(19) United States
(12) Patent Application Publication
(10) Pub. No.: US 2009/0218835 A1
(43) Pub. Date: Sep. 3, 2009

(54) SYSTEM FOR POSITIONING AN OPERATING CYLINDER, USE OF THE SYSTEM, AND MACHINE

(75) Inventor: Erkki Sipila, Kangasala (FI)

Correspondence Address: Studebaker & Brackett PC, 1890 Preston White Drive, Suite 105, Reston, VA, 20191, US

(73) Assignees: Erkki SIPILA, Kanagasala (FI); Jouko HUHTASALO, Pori (FI)

(21) Appl. No.: 12/299,949

(22) PCT Filed: May 4, 2007
(86) PCT No.: PCT/FI2007/000119

§ 371 Date: Mar. 16, 2009

(30) Foreign Application Priority Data
May 9, 2006 (FI) 20060450

(51) Int. Cl. F15B 7/06; B27L 1/00; B25J 15/00; B66C 1/42

(52) U.S. Cl. 294/88; 137/511; 144/208.1

(57) ABSTRACT

In the positioning system for an operating cylinder (1), a valve or a set of valves (6; 10, 11) comprises means for allowing a free supply of hydraulic fluid from a pump fluid chamber (8) of a pump cylinder (7) into an operating fluid chamber (2) of the operating cylinder (1), for preventing the backflow of hydraulic fluid from the operating fluid chamber (2) into the pump fluid chamber (8) when the hydraulic fluid pressure on the control side (A) rises above a predetermined pressure limit, and for allowing a free back flow of hydraulic fluid from the operating fluid chamber (2) into the pump fluid chamber (8) when the hydraulic fluid pressure on the control side (A) goes below the predetermined pressure limit. An operating piston rod (3) follows closely the movement of a pump piston rod (9), and the valve or the set of valves (6; 10, 11) prevents pressure fluctuations from transmitting from the operating side (B) to the control side (A). The system can be used for instance in a hole-rotor-type barking machine (16) for positioning the operating cylinders of barking blades (17). The system can also be used for positioning the operating cylinders (1) operating the gripping jaws (19) of a hydraulic gripper (18) of a machine. Furthermore, the system can preferably be used for positioning the operating cylinders of pusher shafts, lift booms and articulated knuckle booms of a machine.

### FIELD OF THE INVENTION

The invention relates to the system as defined in the preamble of claim 1. The invention also relates to the uses of the system as defined in the preamble of claims 9, 10 and 11. Furthermore, the invention relates to the machine as defined in the preamble of claim 12.

### BACKGROUND OF THE INVENTION

Known in prior art are systems for positioning an operating cylinder in various machines. The operating cylinder is a hydraulic cylinder which operates a tool of a machine. Such an operating cylinder comprises an operating fluid chamber and an operating piston rod for adjusting the operating fluid chamber volume. The system typically comprises some kind of transferring device, such as a pump, for transferring hydraulic fluid into the operating cylinder in order to move the operating piston rod thereof and finally to operate the tool of the machine connected to the operating piston rod. Hydraulic fluid is directed between the transferring device and the operating cylinder via a hydraulic hose that may comprise a valve or valves for controlling the hydraulic fluid flow.

For example in publication FT 111610 B an above-mentioned system has been disclosed, in which system a hydraulic pump cylinder serves as the transferring device. It comprises a pump fluid chamber and a pump piston rod which can be moved to adjust the pump fluid chamber volume. The pump fluid chamber is connected via a hydraulic hose and a valve or a set of valves to an operating fluid chamber for transferring hydraulic fluid between the pump fluid chamber and the operating fluid chamber.

In publication FI 111610 B, the purpose of the operating cylinder is to adjust spring preload by extending and compressing the operating cylinder, which spring turns barking blades towards the log intended for barking. An adjustment member which can be moved in axial direction, a so-called axial bearing, is connected to the rotor of the barking machine, the axial movement of which member extends/compresses the pump cylinders provided in the rotating rotor, and, as the pump fluid chamber volume of the pump cylinders increases/decreases, hydraulic fluid via the hydraulic hose extends/compresses the operating cylinders in order to set their length appropriate for adjusting the blade pressure of the barking blades.

The problem with the system in accordance with the publication is that the adjustment of blade pressure during use is attempted to be accomplished by measuring the pressure from an external hydraulic system which moves the above-mentioned axial adjustment member. In practice, this is not a sufficient basis for the adjustment, nor does it function properly, i.e. fast and accurately enough, because the above-mentioned pressure does not at all indicate the real pressure of the closed hydraulic system formed by the pump and operating cylinders and rotating with the rotor. When beginning the barking of the log, it produces a strong and sudden force bending the blades outwards, which force transmits as a pressure shock from the operating cylinder to the pump cylinder and therefore produces load to the bearing of the axial adjustment member. Also during barking, sudden and strong pressure fluctuations transmit to the bearing of the axial adjustment member. In the example of the embodiment of FIG. 4 in publication FI 111610 B, a pressure accumulator has been arranged between the pump cylinder and the operating cylinder. The pressure accumulator balances the pressure shocks to some extent but not nearly sufficiently, producing heavy load to the axial bearing.

A further problem with the known positioning systems for operating cylinders is typically their complexity which makes them quite expensive.

In positioning, the guiding value used is often the pressure measured from the operating side, which, in many cases, is difficult or quite impossible, such as for example when the operating cylinder is positioned in an inaccessible place, such as in a rotating or remote-controlled part of the machine.

### OBJECTIVE OF THE INVENTION

The objective of the invention is to eliminate the drawbacks referred to above.

One specific objective of the invention is to disclose a system which allows an accurate and fast positioning of a hydraulic operating cylinder.

A further objective of the invention is to disclose a system as inexpensive and simple as possible for positioning a hydraulic operating cylinder.

A further objective of the invention is to disclose a system in which the transmission of pressure fluctuations from the operating cylinder into the pump cylinder has completely been prevented.

Yet another objective of the invention is to disclose a machine in which the gripping jaws of a gripper can be positioned and their pressing pressure adjusted accurately.

### SUMMARY OF THE INVENTION

The system in accordance with the invention is characterized by what has been presented in claim 1. The uses in accordance with the invention are indicated in claims 9, 10 and 11. The machine in accordance with the invention is characterized by what has been presented in claim 12.

The invention relates to the system for positioning an operating cylinder. The operating cylinder is a hydraulic cylinder which operates the machine's tool. The operating cylinder comprises an operating fluid chamber and an operating piston rod for adjusting the operating fluid chamber volume by moving the operating piston rod. The system comprises a transferring device for transferring hydraulic fluid into the operating cylinder in order to move the operating piston rod, and a hydraulic hose for directing hydraulic fluid between the transferring device and the operating cylinder. The system also comprises a valve or a set of valves for controlling the hydraulic fluid flow in the hydraulic hose. The transferring device is a pump cylinder, which is a hydraulic cylinder and comprises a pump fluid chamber and a pump piston rod which can be moved for adjusting the pump fluid chamber volume, and which pump fluid chamber is connected via the hydraulic hose and the valve or the set of valves to the operating fluid chamber for transferring hydraulic fluid between the pump fluid chamber and the operating fluid chamber.

In accordance with the invention, the valve or the set of valves in the system comprises means for allowing a free supply of hydraulic fluid from the pump fluid chamber into the operating fluid chamber, for preventing the back flow of hydraulic fluid from the operating fluid chamber into the pump fluid chamber when the hydraulic fluid pressure on the control side rises above a predetermined pressure limit, said control side being the side of the transferring device with regard to the valve or the set of valves, and for allowing a free back flow of hydraulic fluid from the operating fluid chamber into the pump fluid chamber when the hydraulic fluid pressure on said control side goes below the predetermined pressure limit.

The system can be used for instance in a hole-rotor-type barking machine for positioning the operating cylinders of the barking blades in order to adjust their accurate position and/or working force. The system can also be used for positioning the operating cylinders operating the gripping jaws of a hydraulic gripper of a machine in order to adjust the accurate position and/or pressing force of the gripping jaws. Furthermore, the system can be used for positioning the operating cylinders of pusher shafts, lift booms and articulated knuckle booms of a machine.

The invention also relates to the machine which comprises a gripper. The gripper comprises a gripper body and at least one pair of gripping jaws pivotally connected to the gripper body about mutually parallel pivot axles. Each operating cylinder is connected at one end to the gripper body and at the other end to a gripping jaw for turning the gripping jaws toward each other in order to grip an object and correspondingly away from each other in order to release the object. Each operating cylinder is a hydraulic cylinder and comprises an operating fluid chamber and an operating piston rod for adjusting the operating fluid chamber volume by moving the operating piston rod. The machine further comprises a system for positioning the operating cylinders. The system comprises a transferring device for transferring hydraulic fluid into the operating cylinder in order to move the operating piston rod, a hydraulic hose for directing hydraulic fluid between the transferring device and the operating cylinder, and a valve or a set of valves for controlling the hydraulic fluid flow in the hydraulic hose. The system forms a closed hydraulic circuit.

In accordance with the invention, the transferring device is a pump cylinder, which is a hydraulic cylinder and comprises a pump fluid chamber and a pump piston rod which can be moved for adjusting the pump fluid chamber volume. The pump fluid chamber is connected via the hydraulic hose and the valve or the set of valves to the operating fluid chamber for transferring hydraulic fluid between the pump fluid chamber and the operating fluid chamber. The valve or the set of valves comprises means for allowing a free supply of hydraulic fluid from the pump fluid chamber into the operating fluid chamber, for preventing the back flow of hydraulic fluid from the operating fluid chamber into the pump fluid chamber when the hydraulic fluid pressure on the control side rises above a predetermined pressure limit, said control side being the side of the transferring device with regard to the valve or the set of valves, and for allowing a free back flow of hydraulic fluid from the operating fluid chamber into the pump fluid chamber when the hydraulic fluid pressure on said control side goes below the predetermined pressure limit.

The advantage of the invention is that the operating piston rod follows extremely closely the movement and position of the pump piston rod. The valve or the set of valves prevents potential pressure fluctuations from transmitting from the operating side to the control side. The operating side is the side of the operating cylinder in the system with regard to the valve or the set of valves.

In one embodiment of the system, the means for allowing a free supply of hydraulic fluid comprise a check valve, which allows a free supply of hydraulic fluid from the pump fluid chamber into the operating fluid chamber and prevents the back flow.

In one embodiment of the system, the means for preventing and allowing the back flow of hydraulic fluid from the operating fluid chamber into the pump fluid chamber comprise a pressure control valve, such as a pressure control check valve or the like, the control pressure of which being the pressure of the control side.

In one embodiment of the system, the system comprises a drive device for moving the pump piston rod.

In one embodiment of the system, the drive device is a mechanical, electrical, hydraulic, and/or pneumatic linear drive device.

In one embodiment of the system, the system comprises a position detector for detecting the position of the pump piston rod in order to determine the accurate position of the operating piston rod.

In one embodiment of the system, the system comprises a pressure gauge for measuring the hydraulic pressure of the operating side.

In one embodiment of the system, the system comprises several operating cylinders.

In one embodiment of the machine, the means for allowing a free supply of hydraulic fluid comprise a check valve, which allows a free supply of hydraulic fluid from the pump fluid chamber into the operating fluid chamber and prevents the back flow.

In one embodiment of the machine, the means for preventing and allowing the back flow of hydraulic fluid from the operating fluid chamber into the pump fluid chamber comprise a pressure control valve, such as a pressure control check valve or the like, the control pressure of which being the pressure of the control side.

In one embodiment of the machine, the system comprises a position detector for detecting the position of the pump piston rod in order to determine the accurate position of the operating piston rod.

In one embodiment of the machine, the system comprises a pressure detector for detecting the hydraulic pressure of the control side in order to adjust the pressing pressure of the gripper.

In one embodiment of the machine, the gripper is adapted for gripping a substantially heavy cylindrical object, such as a paper roll.

In one embodiment of the machine, the gripper is adapted for gripping a substantially easily compressible object, such as a cardboard case.

In one embodiment of the machine, the machine is a lift-truck.

In one embodiment of the machine, the machine comprises a pusher shaft, a lift boom and/or an articulated knuckle boom, at one end of which the gripper has been arranged.

In one embodiment of the machine, the machine is a wheeled vehicle, to which the pusher shaft, the lift boom and/or the articulated knuckle boom is connected.

In one embodiment of the machine, the machine is a submersible provided with a gripping arm, at one end of which the gripper has been arranged.

### LIST OF FIGURES

In the following, the invention will be described in detail by means of examples of its embodiments with reference to the accompanying drawing, in which

FIG. 1 represents a hydraulic diagram of a first embodiment of the system in accordance with the invention,

FIG. 2 represents a schematic side view of a machine, namely a forklift truck, provided with a paper roll gripper,

FIG. 3 represents a top view of the forklift truck of FIG. 2,

FIG. 4 represents a hydraulic diagram of the machine of FIG. 2, based on a second embodiment of the system in accordance with the invention,

FIG. 5 represents a schematic view of a barking machine, and

FIG. 6 represents a part of the hydraulic diagram of the barking machine of FIG. 5, based on a third embodiment of the system in accordance with the invention.

### DETAILED DESCRIPTION OF THE INVENTION

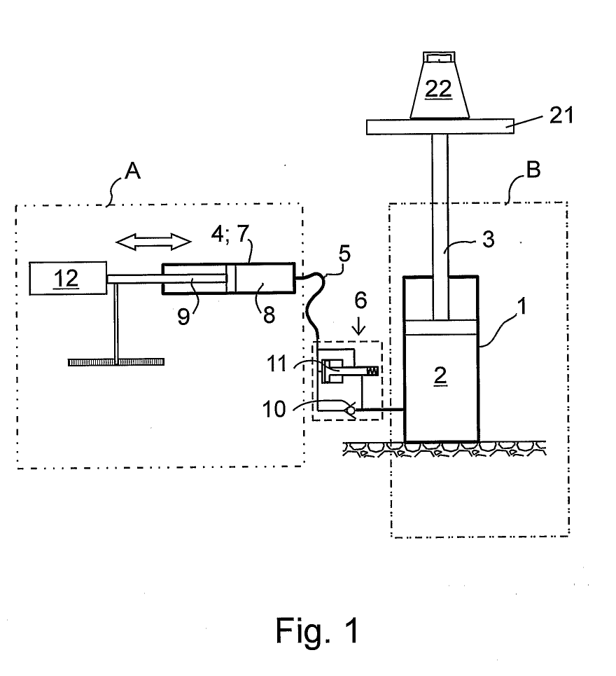

FIG. 1 represents a schematic view of the system for positioning an operating cylinder 1. The example comprises the operating cylinder 1 and a table 21 attached to an operating piston rod 3 thereof, on top of which table a mass 22 has been placed. The operating cylinder comprises an operating fluid chamber 2. The volume of the operating fluid chamber 2 can be adjusted by moving the operating piston rod 3. The system comprises a hydraulic pump cylinder 7, a pump piston rod 9 of which can be moved for transferring hydraulic fluid from a pump fluid chamber 8 of the pump cylinder 7 into the operating fluid chamber 2 and from the operating fluid chamber 2 back into the pump fluid chamber 8, in order to vertically move the operating piston rod 3 and the table 21 attached thereto to a suitable position. Hydraulic fluid is directed between the pump cylinder 7 and the operating cylinder 1 via a hydraulic hose 5. The hydraulic hose 5 is provided with a valve or a set of valves 6 for controlling the hydraulic fluid flow. The system forms a closed hydraulic circuit.

The set of valves 6 comprises a check valve 10 which allows a free supply of hydraulic fluid from the pump fluid chamber 8 into the operating fluid chamber 2, but prevents the back flow. A pressure control valve 11 in turn prevents the back flow of hydraulic fluid from the operating fluid chamber 2 into the pump fluid chamber 8 when the hydraulic fluid pressure on the control side A rises above a predetermined pressure limit. The control pressure of the pressure control valve 11 is thus the pressure of the control side A. The control side A, which in FIG. 1 is indicated in a dot-and-dash line (three dots-two dashes), is the side of the pump cylinder 7 with regard to the valve or the set of valves 6; 10, 11. The pressure control valve 11 allows a free back flow of hydraulic fluid from the operating fluid chamber 2 into the pump fluid chamber 8 when the hydraulic fluid pressure on said control side A goes below a predetermined pressure limit. Said pressure limit is broken immediately when the pressure of the pump fluid chamber 8 of the pump cylinder 7 is lowered by means of moving the pump piston rod 9 such that the volume of the pump fluid chamber 8 increases. The operating piston rod 3 follows closely the movements of the pump piston rod 9, and the valve or the set of valves 6; 10, 11 prevents potential pressure fluctuations from transmitting from the operating side B to the control side A. The operating side B is the side of the operating cylinder 1 with regard to the valve or the set of valves 6; 10, 11, and is indicated in FIG. 1 in a dot-and-dash line (two dots-one dash). The pump piston rod 9 can be moved with any suitable drive device 12. The drive device 12 may be any suitable mechanical, electrical, hydraulic and/or pneumatic linear drive device. The position of the pump piston rod 9 can be determined by means of a position detector 13. With the position of the pump piston rod 9 known, the accurate position of the operating piston rod 3 and therefore of the table 21 are known as well. The user can follow the position detector 13 to adjust the position of the table 21. The operating cylinder 1 may be positioned at a long distance from the pump cylinder 7, so that different tools which may have been positioned in quite inaccessible places can be controlled remotely and very accurately.

Preferably the valve or the set of valves 6 is positioned physically close to the operating cylinder 1, so that a hydraulic hose with low pressure resistance can be used.

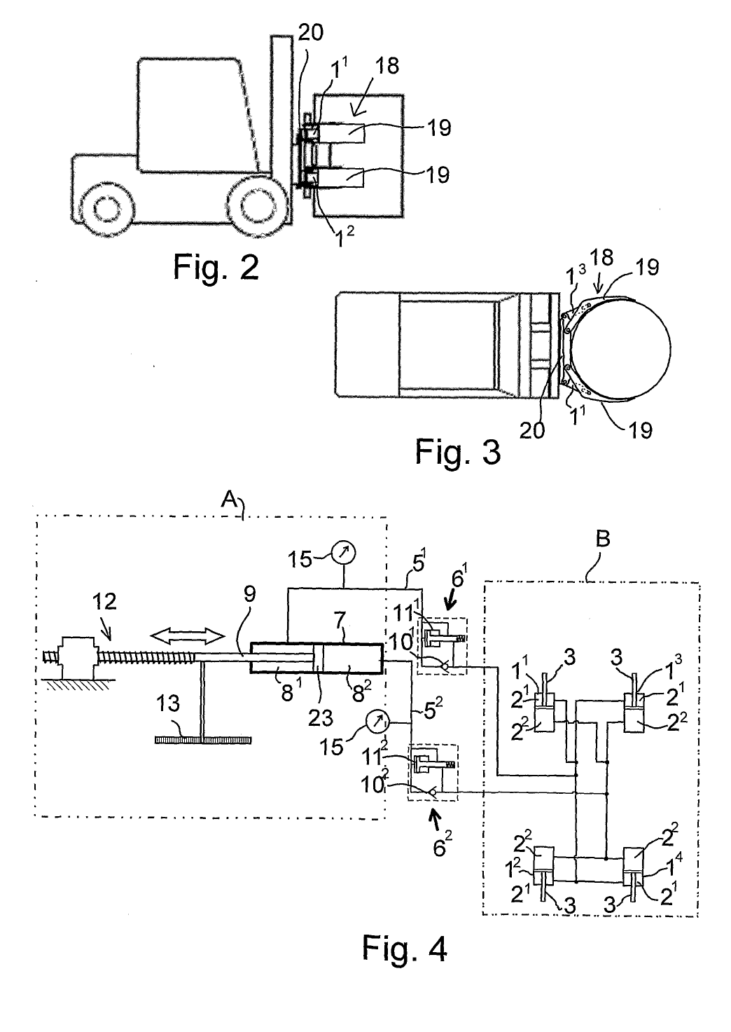

In FIGS. 2 and 3, the machine is a forklift truck provided with a gripper 18. In this example, the gripper 18 is a paper roll gripper. The gripper 18 comprises a gripper body 20 and two pairs of gripping jaws 19, pivotally connected to the gripper body about mutually parallel pivot axles. Each operating cylinder 11, 12, 13, 14 is connected at one end to the gripper body 20 and at the other end to a gripping jaw 19, so that the operating cylinders 11, 12, 13, 14 can be used for bringing the gripping jaws 19 closer to each other in order to grip a paper roll and correspondingly further from each other in order to release the paper roll. An accurate positioning of the gripping jaws 19 is extremely important. Firstly, the accurate positioning allows adjustment of the jaws such that they will not touch any other rolls close to the ones intended for gripping. Secondly, when the jaws have established a grip, the accurate positioning provides a sufficient pressing force so that the paper roll will not slip down from between the jaws. Such slipping damages the top layers of the roll. The grip must therefore be tight, but not too tight, so that the paper roll would not get squeezed between the jaws. The same also applies to cardboard case grippers which grip the opposite sides of a cardboard case. An extremely sensitive adjustment of the pressing force, achieved by the accurate positioning, is required so that the case would not get squeezed nor the case or the contents thereof damaged.

As in the example of FIG. 1, each of the four shown operating cylinders 1¹, 1², 1³, 1⁴ is a hydraulic cylinder which comprises an operating fluid chamber 2 and an operating piston rod 3 for adjusting the volume of the operating fluid chamber 2 by moving the operating piston rod.

Referring to FIG. 4, the positioning system comprises a pump cylinder 7 for transferring hydraulic fluid into operating cylinders 1¹, 1², 1³, 1⁴ in order to move the operating piston rods 3 thereof. It should be noted that only the parts fundamental for the functioning of the invention are shown in the diagram. It may comprise other components as well. However, the essential feature is that the system forms a closed hydraulic circuit. The hydraulic fluid flow in the hydraulic hoses 5 is controlled by means of a valve or a set of valves 6. The pump cylinder 7 is herein a double-acting hydraulic cylinder. The pump cylinder 7 comprises two pump fluid chambers 8¹, 8² positioned on each side of a piston 23, and a pump piston rod 9 which can be moved for adjusting the volume of the pump fluid chambers 8¹, 8². The first pump fluid chamber 8¹ is connected via the first hydraulic hose 5¹ and the first valve or the set of valves 10¹, 11¹ to the first operating fluid chamber 2¹ of the double-acting operating cylinders 1¹, 1², 1³, 1⁴ so that hydraulic fluid can be transferred between the first pump fluid chamber 8¹ and the first operating fluid chambers 2¹. The check valve 10¹ allows a free supply of hydraulic fluid from the first pump fluid chamber 8¹ into the first operating fluid chamber 2¹ and prevents the backflow. The pressure control valve 11¹ prevents the backflow of hydraulic fluid from the first operating fluid chamber 2¹ into the first pump fluid chamber 8¹ when the hydraulic fluid pressure on the control side A rises above a predetermined pressure limit. The pressure control valve 11¹ allows a free backflow of hydraulic fluid from the first operating fluid chamber 2¹ into the first pump fluid chamber 8¹ when the hydraulic fluid pressure on said control side A goes below the predetermined pressure limit.

Accordingly, the second pump fluid chamber 8² is connected via the second hydraulic hose 5² and the second valve or the set of valves 10², 11² to the second operating fluid chamber 2² of the double-acting operating cylinders 1¹, 1², 1³, 1⁴ so that hydraulic fluid can be transferred between the second pump fluid chamber 8² and the second operating fluid chambers 2². The check valve 10² allows a free supply of hydraulic fluid from the second pump fluid chamber 8² into the operating fluid chamber 2² and prevents the backflow. The pressure control valve 11² prevents the backflow of hydraulic fluid from the second operating fluid chamber 2² into the second pump fluid chamber 8² when the hydraulic fluid pressure on the control side A rises above a predetermined pressure limit. The pressure control valve 11² allows a free backflow of hydraulic fluid from the second operating fluid chamber 2² into the second pump fluid chamber 8² when the hydraulic fluid pressure on said control side A goes below the predetermined pressure limit. The operating piston rods 3 follow thus closely the movements of the pump piston rod 9. The system of FIG. 4 also comprises a position detector 13 for detecting the position of the pump piston rod 9 in order to determine the accurate position of the operating piston rods 3. In FIG. 4, an electrical ball-race screw drive device has been arranged to move the piston rod 9 of the pump cylinder 7. Compared to a hydraulic drive device, an electrical drive provides the advantage of not needing to draw hydraulic hoses to a position that is difficult to access, but instead only an electrical wire for conducting electrical energy to the drive device is required.

The system also comprises a pressure detector 15 for detecting the hydraulic pressure of the control side A in order to accurately adjust the pressing pressure applied from the gripping jaws to the object. The pressure detector may be a pressure sensor which gives a pressure indicating signal to a control device. To limit the pressing pressure, a maximum value can be set for the pressure of the control side A, which maximum value may not be exceeded and can be used in an automated system by the control device for adjusting the drive device 12 in order to adjust the pressure of the operating side B and therefore the pressing pressure of the gripping jaws, so that the operating cylinder would not use excessive power. Alternatively, the pressure detector 15 may be a pressure gauge, the value indicated by which gauge the user of the machine may follow in order to adjust the drive device 12 using a manual control device. Once the gripper has established a grip of the object, but there is not yet any pressing pressure, it will be adjusted using the pressure detector. The adjustment of the pressing pressure will thus be accomplished by moving the pump piston rod of the pump cylinder by means of the drive device.

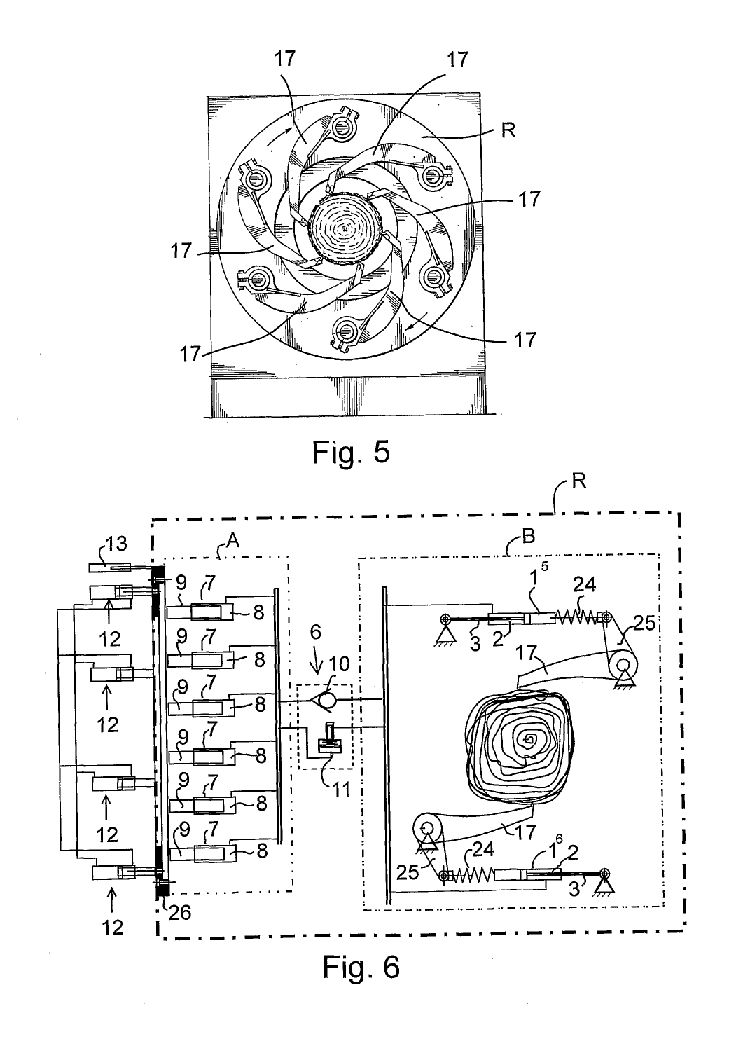

FIGS. 5 and 6 represent, as yet another embodiment of the invention, a hole-rotor-type barking machine. A log is fed perpendicularly to the image plane of FIG. 5 through the center hole of the rotating rotor R so that barking blades 17, pivotally connected to the rotor R, bark the log.

FIG. 6 represents the positioning system for positioning the operating cylinders 1. Each operating cylinder 1 is connected via a spring 24 to a swinging arm 25, which is fixedly connected to a barking blade 17. The operating cylinder 1 adjusts the stretch of the spring 24 and thereby the position of the barking blades as well as the blade pressure against the log.

The stretch of the springs 24 can be completely changed regardless of the pressure of the operating cylinders 1. The pressure of the barking blades against the log can be changed by continuous control throughout the total length of the log, and the required pressure can be calculated and changed at any time, regardless of the load. Calculations and adjustments can thus be easily automated.

The valve 6 allows a free fluid flow from the control side A into the operating cylinders 1, but prevents the instantaneous pressure, active in the operating cylinders 1, from transmitting back to the control system, thus preventing any unnecessary loads to the control side A, without affecting in any way the realization of the adjustment. The zero point for functioning of the valve 6 is set to the level of the pressure limit, such that the feed pressure below the pressure limit allows the backflow of hydraulic fluid from the operating cylinders back to the control side, thus reducing the amount of fluid active in the operating cylinders 1 and thereby extending the length of the released position of the combination formed by the spring 24 and the operating cylinder 1 and producing load to the barking blades. The pressure of the barking blades against the log can be adjusted from zero to the maximum value completely continuously during use. The system adjusts the stretch of the springs producing load to the barking blades by alternating the length of the operating cylinders extending from the springs, based on the amount of hydraulic fluid in the operating fluid chambers 2, and is not dependent of pressure fluctuations of the operating cylinders 1 resulting from the load produced to the machine.

The pump cylinders 7 feed a desired amount of hydraulic fluid which is measured by the position sensor 13. The check valve 10 lets the fluid flow freely into the cylinders 1 which adjust the barking pressure of the blades and preload the extension springs 24 according to the amount of fluid fed therein. The greater the amount of fluid in the operating fluid chambers 2 of the operating cylinders 1 which produce load to the springs, i.e. the shorter the length of the operating cylinder 1, the greater the power used by the springs 24 to press the blades 17 against the log intended for barking. The pressure control valve 11 closes to the back flow direction every time the feed pressure exceeds the pressure limit set for the valve 11. To relieve the blade pressure, the amount of fluid in the operating cylinder 1 can be reduced by increasing the amount of fluid in the pump fluid chamber 8 of the pump cylinder 7 to the amount corresponding to the desired amount of fluid, such that the feed pressure drops below the afore-mentioned pressure limit, and, as the back flow quickly fills the ullage formed in the pump cylinder 7, the pressure rises again until it corresponds to the pressure limit, thus stopping the backflow at the desired amount. The system forms a closed hydraulic circuit.

Preferably, the power is directed to the pump cylinder 7 by means of a separate thrust bearing 26 which can be loaded axially to both directions by axial shifting thereof, according to the description of patent FI 111610 B, however, the power may also be led to the pump cylinder 7 or the valve 6; 10, 11 by means of oil pressure using a rotating connector between the stator and the rotor. In the latter case, the system efficiently prevents strong pressure fluctuations on the operating side B from affecting the connector, which could lead to leakage of hydraulic fluid and other such problems.

The invention is not limited merely to the examples of its embodiments referred to above; instead many variations are possible within the scope of the inventive idea defined by the claims.

1-22. (canceled)

23. A system for positioning an operating cylinder, which operating cylinder is a hydraulic cylinder which operates a tool of a machine, and which operating cylinder comprises an operating fluid chamber and an operating piston rod for adjusting the operating fluid chamber volume, which system comprises a transferring device for transferring hydraulic fluid into the operating cylinder in order to move the operating piston rod, a hydraulic hose for directing hydraulic fluid between the transferring device and the operating cylinder, and a valve or a set of valves for controlling the hydraulic fluid flow in the hydraulic hose, and in which system the transferring device is a pump cylinder which is a hydraulic cylinder and comprises a pump fluid chamber and a pump piston rod which can be moved for adjusting the pump fluid chamber volume, which pump fluid chamber is connected via the hydraulic hose and the valve or the set of valves to the operating fluid chamber for transferring hydraulic fluid between the pump fluid chamber and the operating fluid chamber, so that the system forms a closed hydraulic circuit, wherein the valve or the set of valves comprises means for allowing a free supply of hydraulic fluid from the pump fluid chamber into the operating fluid chamber, for preventing the back flow of hydraulic fluid from the operating fluid chamber into the pump fluid chamber when the hydraulic fluid pressure on the control side rises above a predetermined pressure limit, said control side being the side of the transferring device with regard to the valve or the set of valves, and for allowing a free back flow of hydraulic fluid from the operating fluid chamber into the pump fluid chamber when the hydraulic fluid pressure on said control side goes below the predetermined pressure limit.

24. The system according to claim 23, wherein the means for allowing a free supply of hydraulic fluid comprise a check valve which allows a free supply of hydraulic fluid from the pump fluid chamber into the operating fluid chamber and prevents the back flow.

25. The system according to claim 23, wherein the means for preventing and allowing the back flow of hydraulic fluid from the operating fluid chamber into the pump fluid chamber comprise a pressure control valve, such as a pressure control check valve or the like, the control pressure of which being the pressure of the control side.

26. The system according to claim 23, further comprising a drive device for moving the pump piston rod.

27. The system according to claim 26, wherein the drive device is a mechanical, electrical, hydraulic and/or pneumatic linear drive device.

28. The system according to claim 23, further comprising a position detector for detecting the position of the pump piston rod in order to determine the accurate position of the operating piston rod.

29. The system according to claim 23, further comprising a pressure detector for detecting the hydraulic pressure of the control side.

30. The system according claim 23, further comprising several operating cylinders.

31. Use of the system according to claim 23, in a hole-rotor-type barking machine for positioning the operating cylinders of the barking blades in order to adjust the accurate position and/or power of the barking blades.

32. Use of the system according to claim 23, for positioning the operating cylinders operating the gripping jaws of a hydraulic gripper of a machine in order to adjust the accurate position and/or pressing force of the gripping jaws.

33. Use of the system according to claim 23, for positioning the operating cylinders of pusher shafts, lift booms, articulated knuckle booms and/or robotic arms of a machine.

34. A machine comprising:
a gripper which comprises a gripper body, at least one pair of gripping jaws, pivotally connected to the gripper body about mutually parallel pivot axles, and operating cylinders, each connected at one end to the gripper body and at the other end to a gripping jaw for turning the gripping jaws toward each other in order to grip an object, and correspondingly away from each other in order to release the object, and wherein each operating cylinder is a hydraulic cylinder comprising an operating fluid chamber and an operating piston rod for adjusting the volume of the operating fluid chamber, and
a system for positioning the operating cylinders, which system comprises a transferring device for transferring hydraulic fluid into the operating cylinder in order to move the operating piston rod, a hydraulic hose for directing hydraulic fluid between the transferring device and the operating cylinder, and a valve or a set of valves for controlling the hydraulic fluid flow in the hydraulic hose, and which system forms a closed hydraulic circuit, wherein the transferring device is a pump cylinder, which is a hydraulic cylinder and comprises a pump fluid chamber and a pump piston rod which can be moved for adjusting the pump fluid chamber volume, which pump fluid chamber is connected via a hydraulic hose and a valve or a set of valves, to the operating fluid chamber for transferring hydraulic fluid between the pump fluid chamber and the operating fluid chamber, and in that the valve or the set of valves comprises means for allowing a free supply of hydraulic fluid from the pump fluid chamber into the operating fluid chamber, for preventing the back flow of hydraulic fluid from the operating fluid chamber into the pump fluid chamber when the hydraulic fluid pressure on the control side rises above a predetermined pressure limit, said control side being the side of the transferring device with regard to the valve or the set of valves, and for allowing a free back flow of hydraulic fluid from the operating fluid chamber into the pump fluid chamber when the hydraulic fluid pressure on said control side goes below the predetermined pressure limit.

35. The machine according to claim 34, wherein the means for allowing a free supply of hydraulic fluid comprise a check valve which allows a free supply of hydraulic fluid from the pump fluid chamber into the operating fluid chamber and prevents the back flow.

36. The machine according to claim 34, wherein the means for preventing and allowing the back flow of hydraulic fluid from the operating fluid chamber into the pump fluid chamber comprise a pressure control valve, such as a pressure control check valve or the like, the control pressure of which being the pressure of the control side.

37. The machine according to claim 34, comprising a position detector for detecting the position of the pump piston rod in order to determine the accurate position of the operating piston rod.

38. The machine according to claim 34, further comprising a pressure detector for detecting the hydraulic pressure of the control side in order to accurately adjust the pressing pressure applied to the object from the gripping jaws.

39. The machine according to claim 34, wherein the gripper is adapted for gripping a substantially heavy, cylindrical object, such as a paper roll.

40. The machine according to any claim 34, wherein the gripper is adapted for gripping a substantially easily compressible object, such as a cardboard case.

41. The machine according to claim 34, wherein the machine is a lift truck.

42. The machine according to claim 34, wherein the machine comprises a pusher shaft, a lift boom and/or an articulated knuckle boom, at one end of which the gripper has been arranged.

43. The machine according to claim 42, wherein the machine is a wheeled vehicle, to which the pusher shaft, the lift boom and/or the articulated knuckle boom has been connected.

44. The machine according to claim 34, wherein the machine is a submersible provided with a gripping arm; and in that the gripper has been arranged at one end of the arm.
